(19) United States
(12) Patent Application Publication
(10) Pub. No.: US 2015/0308275 A1
(43) Pub. Date: Oct. 29, 2015

(54) COATING METHOD AND COATED ARTICLE

(71) Applicant: GENERAL ELECTRIC COMPANY, Schenectady, NY (US)

(72) Inventors: Surinder Singh PABLA, Greer, SC (US); Krishnamurthy ANAND, Bangalore (IN); Prajina BHATTACHARYA, Bangalore (IN); Bala Srinivasan PARTHASARATHY, Bangalore (IN); Arun KUMAR, Bangalore (IN)

(73) Assignee: GENERAL ELECTRIC COMPANY, Schenectady, NY (US)

(21) Appl. No.: 14/264,170

(22) Filed: Apr. 29, 2014

(51) Int. Cl. F01D 5/28; B05D 3/12; B05D 1/36

(52) U.S. Cl. CPC F01D 5/288; B05D 1/36; B05D 3/12

(57) ABSTRACT

A coating method and a coated article are disclosed. Forming a coating includes providing a substrate having a substrate surface, forming on the substrate surface at least one bond coating layer defining a bond coating surface, and forming on the bond coating surface at least one oxide coating layer defining an oxide coating surface. A coated article includes a substrate having the coating formed thereupon. The oxide coating layer is more resistive to increasing the oxide coating surface roughness (Rₐ) than either the bond coating layer is resistive to increasing the bond coating surface roughness (Rₐ) or the substrate is resistive to increasing the substrate surface roughness (Rₐ).

### FIELD OF THE INVENTION

The present invention is directed to a coating method and a coated article. More specifically, the present invention is directed to a method for applying a coating and a coated article wherein the coating includes at least one bond coating layer and at least one oxide coating layer.

### BACKGROUND OF THE INVENTION

Gas turbine and steam turbine components, particularly rear stage gas turbine compressor blades, rear stage gas turbine compressor stators, steam turbine high pressure buckets, steam turbine intermediate pressure buckets and steam turbine casings, are subjected to conditions that may cause corrosion, oxidation, deposition and/or erosion during service exposure.

The components may be formed from a variety of materials, including compositions such as, by weight percent: less than about 0.07% carbon, less than about 1.00% manganese, less than about 0.04% phosphorus, less than about 0.03% sulfur, less than about 1.0% sulfur, about 15.0% to about 17.5% chromium, about 3.0% to about 5.0% nickel, about 3.0% to about 5.0% copper, and about 0.15% to about 0.45% columbium and tantalum combined, balance iron (e.g., 17-4PH stainless steel available from AK Steel); less than about 0.05% carbon, about 14% to about 16% chromium, about 1.25% to about 1.75% carbon, less than about 1% manganese, about 0.5% to about 1% molybdenum, about 5% to about 7% nickel, less than about 0.03% phosphorous, less than about 1% silicon, less than about 0.03% sulfur, niobium present at least about 8 times the amount of carbon present, balance iron (e.g., stainless steel alloy 450); and about 0.13% to about 0.18% carbon, less than about 0.50% silicon, about 0.4% to about 0.6% manganese, less than about 0.025% phosphorous, less than about 0.01% silicon, less than about 13.0% chromium, less than about 0.2% molybdenum, less than about 0.6% nickel, about 0.15% to about 0.25% niobium, less than about 0.1% vanadium, less than about 0.005% lead, less than about 0.05% tin, less than about 0.05% aluminum, balance iron (e.g., stainless steel alloy 403Cb(ESR), available from Gloria Material Technology Corporation).

Operating conditions may result in undesirable increases in surface roughness (Rₐ). For example, field data from exposed surfaces of known components have shown an observed surface roughness (Rₐ) ranging from 40 to 160 microinches under operating conditions. This observed surface roughness (Rₐ) generally exceeds the recognized standard of a surface roughness (Rₐ) of 25 microinches or less for good aerodynamic performance.

Under operating conditions, particles are present which are believed to stem from upstream carbon steel and cast iron parts in the fluid path of the turbine. Water wash cycles are often performed to remove the particulates. However, the water wash cycles expose the components to increased amounts of moisture, and may further utilize chemicals, that may increase the surface roughness (Rₐ) of the components.

Undesirable increases in surface roughness (Rₐ), may decrease the efficiency of the turbine. Coated components and methods of coating components that do not suffer from one or more of the above drawbacks would be desirable in the art.

### BRIEF DESCRIPTION OF THE INVENTION

In one embodiment, a method for applying a coating includes providing a substrate defining a substrate surface having a substrate surface roughness (Rₐ). At least one bond coating layer defining a bond coating surface having a bond coating surface roughness (Rₐ) is formed on the substrate surface. At least one oxide coating layer defining an oxide coating surface having an oxide coating surface roughness (Rₐ) is formed on the bond coating surface. The oxide coating layer is more resistive to increasing the oxide coating surface roughness (Rₐ) than either the bond coating layer is resistive to increasing the bond coating surface roughness (Rₐ) or the substrate is resistive to increasing the substrate surface roughness (Rₐ).

In another embodiment, a coated article includes a coating and a substrate defining a substrate surface having a substrate surface roughness (Rₐ). The coating includes at least one bond coating layer defining a bond coating surface having a bond coating surface roughness (Rₐ), wherein the at least one bond coating layer is formed on the substrate surface. The coating also includes at least one oxide coating layer defining an oxide coating surface having an oxide coating surface roughness (Rₐ), wherein the at least one oxide coating layer is formed on the bond coating surface. The oxide coating layer is more resistive to increasing the oxide coating surface roughness (Rₐ) than either the bond coating layer is resistive to increasing the bond coating surface roughness (Rₐ) or the substrate is resistive to increasing the substrate surface roughness (Rₐ).

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a coated article, according to an embodiment of the disclosure.

FIG. 2 is a sectional view along lines 2-2 of FIG. 1 of the coated article, according to an embodiment of the disclosure.

FIG. 3 is a sectional view along lines 2-2 of FIG. 1 of the coated article having an oxide coating layer including a plurality of phases, according to another embodiment of the disclosure.

Wherever possible, the same reference numbers will be used throughout the drawings to represent the same parts.

### DETAILED DESCRIPTION OF THE INVENTION

Provided are a coating method and a coated article. Embodiments of the present disclosure, in comparison to methods and articles not using one or more of the features disclosed herein, decrease component corrosion, decrease component oxidation, decrease component fouling, decrease component erosion, decrease the rate at which the surface roughness (Rₐ) of a component increases, decrease maintenance costs, increase efficiency, or a combination thereof.

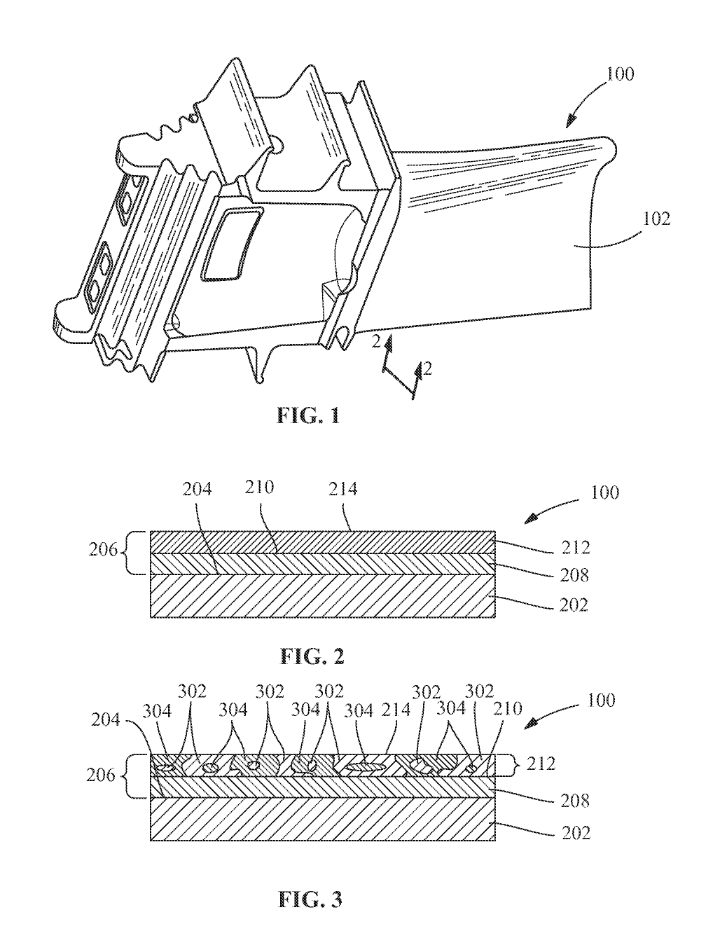

Referring to FIG. 1, in one embodiment, a coated article 100 is depicted. The coated article 100 is a gas turbine compressor blade 102 (shown), a gas turbine compressor stator, a turbine high pressure bucket, a turbine intermediate pressure bucket, a turbine casing, or any other suitable component, or a combination thereof. The coated article 100 is a portion of any suitable system, for example, a power generation system or a turbine engine system.

Referring to FIG. 2, in one embodiment, the coated article 100 includes a substrate 202 defining a substrate surface 204 having a substrate surface roughness (Rₐ), and a coating 206 on the substrate surface 204. The coating 206 includes at least one bond coating layer 208 and at least one oxide coating layer 212. The bond coating layer 208 defines a bond coating surface 210 having a bond coating surface roughness (Rₐ). The at least one oxide coating layer 212 is applied to the bond coating surface 210. The at least one oxide coating layer 212 defines an oxide coating surface 214 having an oxide coating surface roughness (Rₐ). The oxide coating layer 212 is more resistive to increasing the oxide coating surface roughness (Rₐ) than either the bond coating layer 208 is resistive to increasing the bond coating surface roughness (Rₐ) or the substrate 202 is resistive to increasing the substrate surface roughness (Rₐ). Resistivity to increasing surface roughness (Rₐ) is a material property representing the rate of a surface becoming roughened, for example due to corrosion, oxidation, deposition and/or erosion as a result of the operating conditions of a gas turbine.

In one embodiment, the roughness (Rₐ) of the oxide coating surface 214 is less than about 0.64 μm (25 μin), alternatively between about 0.13 μm (5 μin) to about 0.64 μm (25 μin), alternatively between about 0.38 μm (15 μin) to about 0.64 μm (25 μin), alternatively between about 0.25 μm (10 μin) to about 0.51 μm (20 μin), alternatively between about 0.13 μm (5 μin) to about 0.38 μm (15 μin).

In one embodiment, the at least one bond coating layer 208 is a sacrificial coating and is anodic with respect to the substrate 202. In a further embodiment, the at least one bond coating layer 208 includes a mixture of Ni_{80%}Al_{20%} (wt %) and Ni_{95%}Al_{5%} (wt %), cobalt and aluminum particles in a chromate/phosphate binder, a sacrificial metallic undercoat with a ceramic overcoat, a metallurgically bonded aluminide with an aluminum surface layer, a chemically bonded aluminide with an aluminum surface layer, a mechanically bonded aluminide with an aluminum surface layer, or a combination thereof. The at least one bond coating layer 208 is operative to protect the substrate surface 204 from corrosion during downtime, which may occur in peaking machines or even in base loaded machines.

In one embodiment, the at least one oxide coating layer 212 includes at least one oxide prevention phase, at least one deposit prevention phase, or a combination thereof. In one embodiment, the at least one oxide prevention phase includes alumina, a mixture of alumina and between about 3% to about 30% by weight titania, zirconia, or a combination thereof. In another embodiment, the at least one deposit prevention phase includes ceria, cerium-zirconium oxide, barium-cerium oxide, or a combination thereof.

In one embodiment, the method of forming the coating 206 includes providing the substrate 202 having the substrate surface 204, forming the at least one bond coating layer 208 on the substrate surface 204, and forming the at least one oxide coating layer 212 on the bond coating surface 210. Forming the at least one bond coating layer 208 on the substrate surface 204, and forming the at least one oxide coating layer 212 on the bond coating surface 210 may be accomplished by any suitable coating techniques, such as, but not limited to, thermal spray, sol-gel, slurry coating or a combination thereof.

In an alternate embodiment, the method of forming the coating 206 further includes at least one of grinding and polishing the oxide coating surface 214 with a fine slurry to reduce the oxide coating surface roughness (Rₐ). Grinding or polishing of the oxide coating surface 214 may be accomplished using any suitable techniques, such as, but not limited to, a tumbling based mass finishing technique. The fine slurry may include particles of cubic boron nitride, diamond, silicon carbide, pumice stone, or combinations thereof. The particle size in the fine slurry is generally less than about five microns.

Referring to FIG. 3, in one embodiment, the at least one oxide layer 212 includes at least one oxide prevention phase 302 and at least one deposit prevention phase 304.

In one embodiment, the at least one oxide prevention phase 302 is operative to provide greater resistance to increases in the oxide coating surface roughness (Rₐ) caused by oxidation than either the bond coating layer 208 would provide to increases in the bond coating surface roughness (Rₐ) or the substrate 202 would provide to increases in the substrate surface roughness (Rₐ). In another embodiment, the at least one oxide prevention phase 302 includes alumina, a mixture of alumina and between about 3% to about 30% by weight titania, zirconia, or a combination thereof. Without being bound by theory, it is believed that because the oxide prevention phase 302 includes materials which are oxides, these materials will not undergo further oxidation.

In one embodiment, the at least one deposit prevention phase 304 is operative to provide greater resistance to increases in the oxide coating surface roughness (Rₐ) caused by deposition than either the bond coating layer 208 would provide to increases in the bond coating surface roughness (Rₐ) or the substrate 202 would provide to increases in the substrate surface roughness (Rₐ). In another embodiment, the at least one deposit prevention phase 304 includes ceria, cerium-zirconium oxide, barium-cerium oxide, or a combination thereof. Without being bound by theory, it is believed that the stoichiometry of the at least one deposit prevention phase 304 renders the oxide coating surface 214 somewhat electrostatically positive, thereby reducing the tendency of the oxide coating surface 214 to attract carbonaceous deposits. Also without being bound by theory, it is further believed that rare earth modified oxides tend to have oxygen vacancies resulting in surfaces which are oxygen deficient, and polar molecules are less likely to adsorb onto such oxygen deficient surfaces which are as a result considered to be anti-stick surfaces.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for applying a coating, comprising:
providing a substrate defining a substrate surface having a substrate surface roughness (Rₐ);
forming on the substrate surface at least one bond coating layer defining a bond coating surface having a bond coating surface roughness (Rₐ); and
forming on the bond coating surface at least one oxide coating layer defining an oxide coating surface having an oxide coating surface roughness (Rₐ),
wherein the oxide coating layer is more resistive to increasing the oxide coating surface roughness (Rₐ) than either the bond coating layer is resistive to increasing the bond coating surface roughness (Rₐ) or the substrate is resistive to increasing the substrate surface roughness (Rₐ).

2. The method of claim 1, wherein the at least one oxide coating layer comprises at least one material, wherein the at least one material is selected from a group consisting of at least one oxide prevention phase, at least one deposit prevention phase, and combinations thereof.

3. The method of claim 2, wherein the at least one oxide prevention phase is selected from a group consisting of alumina, a mixture of alumina and between about 3% to about 30% by weight titania, zirconia, and combinations thereof.

4. The method of claim 2, wherein the at least one deposit prevention phase is selected from a group consisting of ceria, cerium-zirconium oxide, barium-cerium oxide, and combinations thereof.

5. The method of claim 2, wherein the at least one oxide coating layer comprises at least one oxide prevention phase and at least one deposit prevention phase.

6. The method of claim 5, wherein:
the at least one oxide prevention phase is selected from a group consisting of alumina, a mixture of alumina and between about 3% to about 30% by weight titania, zirconia, and combinations thereof; and
the at least one deposit prevention phase is selected from a group consisting of ceria, cerium-zirconium oxide, barium-cerium oxide, and combinations thereof.

7. The method of claim 1, further comprising at least one of grinding and polishing the oxide coating surface with a fine slurry.

8. The method of claim 1, wherein the at least one bond coating layer is a sacrificial coating and is anodic with respect to the substrate.

9. The method of claim 8, wherein the at least one bond coating layer is selected from a group consisting of a mixture of Ni_{80%}Al_{20%}(wt %) and Ni_{95%}Al_{5%} (wt %), cobalt and aluminum particles in a chromate/phosphate binder, a sacrificial metallic undercoat with a ceramic overcoat, a metallurgically bonded aluminide with an aluminum surface layer, a chemically bonded aluminide with an aluminum surface layer, a mechanically bonded aluminide with an aluminum surface layer, and combinations thereof.

10. The method of claim 1, wherein the substrate is selected from a group consisting of a gas turbine compressor blade, a gas turbine compressor stator, a turbine high pressure bucket, a turbine intermediate pressure bucket, and a turbine casing.

11. A coated articled, comprising:
a substrate defining a substrate surface having a substrate surface roughness (Rₐ); and
a coating, wherein the coating includes:
at least one bond coating layer defining a bond coating surface having a bond coating surface roughness (Rₐ), wherein the at least one bond coating layer is formed on the substrate surface; and
at least one oxide coating layer defining an oxide coating surface having an oxide coating surface roughness (Rₐ), wherein the at least one oxide coating layer is formed on the bond coating surface,
wherein the oxide coating layer is more resistive to increasing the oxide coating surface roughness (Rₐ) than either the bond coating layer is resistive to increasing the bond coating surface roughness (Rₐ) or the substrate is resistive to increasing the substrate surface roughness (Rₐ).

12. The coated article of claim 11, wherein the at least one oxide coating layer comprises at least one material, wherein the at least one material is selected from a group consisting of at least one oxide prevention phase, at least one deposit prevention phase, and combinations thereof.

13. The coated article of claim 12, wherein the at least one oxide prevention phase is selected from a group consisting of alumina, a mixture of alumina and between about 3% to about 30% by weight titania, zirconia, and combinations thereof.

14. The coated article of claim 12, wherein the at least one deposit prevention phase is selected from a group consisting of ceria, cerium-zirconium oxide, barium-cerium oxide, and combinations thereof.

15. The coated article of claim 12, wherein the at least one oxide coating layer comprises at least one oxide prevention phase and at least one deposit prevention phase.

16. The coated article of claim 15, wherein:
the at least one oxide prevention phase is selected from a group consisting of alumina, a mixture of alumina and between about 3% to about 30% by weight titania, zirconia, and combinations thereof; and
the at least one deposit prevention phase is selected from a group consisting of ceria, cerium-zirconium oxide, barium-cerium oxide, and combinations thereof.

17. The coated article of claim 11, wherein the oxide coating surface roughness (Rₐ) is between about 0.13 micrometers (5 microinches) to about 0.64 micrometers (25 microinches).

18. The coated article of claim 11, wherein the at least one bond coating layer is a sacrificial coating and is anodic with respect to the substrate.

19. The coated article of claim 18, wherein the at least one bond coating layer is selected from a group consisting of a mixture of Ni_{80%}Al_{20%}(wt %) and Ni_{95%}Al_{5%} (wt %), cobalt and aluminum particles in a chromate/phosphate binder, a sacrificial metallic undercoat with a ceramic overcoat, a metallurgically bonded aluminide with an aluminum surface layer, a chemically bonded aluminide with an aluminum surface layer, a mechanically bonded aluminide with an aluminum surface layer, and combinations thereof.

20. The coated article of claim 11, wherein the substrate is selected from a group consisting of a gas turbine compressor blade, a gas turbine compressor stator, a turbine high pressure bucket, a turbine intermediate pressure bucket, and a turbine casing.
